(19) United States
(12) Patent Application Publication
(10) Pub. No.: US 2026/0128610 A1
(43) Pub. Date: May 7, 2026

(54) CURRENT SWITCHING DEVICE FOR EMERGENCY START POWER SUPPLY OF CAR

(71) Applicant: Shenzhen Benrong New Energy Technology Co., Ltd, Shenzhen (CN)

(72) Inventors: YaoTian YAO, Shenzhen (CN); KaiJian QIU, Shenzhen (CN); JiongLang XU, Shenzhen (CN); Di ZHANG, Shenzhen (CN)

(21) Appl. No.: 18/960,432

(22) Filed: Nov. 26, 2024

(30) Foreign Application Priority Data
Nov. 4, 2024 (CN) 202422673515X

(51) Int. Cl. H02J 7/00; H02J 7/34

(52) U.S. Cl. CPC H02J 7/94; H02J 7/342; H02J 7/80; H02J 7/855; H02J 7/96

(57) ABSTRACT

Provided is a current switching device for an emergency start power supply of a car, including: a lithium battery voltage sampling circuit configured to collect a lithium battery voltage in the emergency start power supply; a battery voltage sampling circuit configured to collect a battery voltage of the car; a control module configured to output a first control signal and a second control signal based on the lithium battery voltage and the battery voltage; a precharging circuit configured to transmit lithium battery energy of the emergency start power supply into a battery based on a first current when the first control signal is at a high level; and a relay configured to transmit the lithium battery energy of the emergency start power supply into the battery based on a second current when the second control signal is at a high level.

### FIELD OF TECHNOLOGY

The present utility model relates to the field of emergency start power supplies of cars, specifically to a current switching device for an emergency start power supply of a car.

### BACKGROUND

With the improvement of living standards, the number of cars owned by people is increasing. Due to the wide variety of cars on the market, the quality of various parts, especially battery components, varies greatly. Moreover, various improper usage habits of different car owners easily lead to a decline in performance of a car battery, making it prone to low power and failing to ignite. In such a case, an emergency start power supply is needed to quickly release electrical energy from a lithium battery to the car battery in a short time, thereby helping start a car engine.

The key component of an emergency power supply of a car is an intelligent switching circuit connected between a high-rate lithium battery and a car battery. The circuit not only requires instantaneous conduction of a current of more than 100 A to provide electrical energy required for car start, but also requires various comprehensive protection functions.

At present, the solution of the intelligent switching circuit on the market is realized generally with a high-direct-current relay, which has great defects in technical design. First, the main circuit controls the on/off of a ground return circuit, which brings the inconvenience to voltage sampling for the car battery and reduces the time delay and accuracy of voltage sampling, thereby easily causing the start current to fail to meet the requirements; and secondly, the relay is not effectively protected, so that the relay contacts are easily adhered at a high temperature to lose the switching performance, thus greatly shortening the service life of the relay.

### SUMMARY

To solve the problem of a decrease in time delay and accuracy of voltage sampling in the prior art, the present utility model provides a current switching device for an emergency start power supply of a car. A control module can conveniently and accurately sample a battery voltage of the car online, thereby stably implementing a function of emergency start of the car.

To achieve the above objective, a specific solution adopted by the present utility model is as follows:

A current switching device for an emergency start power supply of a car, including:
a lithium battery voltage sampling circuit configured to collect a lithium battery voltage in the emergency start power supply;
a battery voltage sampling circuit configured to collect a battery voltage of the car;
a control module configured to output a first control signal and a second control signal based on the lithium battery voltage and the battery voltage;
a precharging circuit configured to transmit lithium battery energy of the emergency start power supply into a battery based on a first current when the first control signal is at a high level; and
a relay configured to transmit the lithium battery energy of the emergency start power supply into the battery based on a second current when the second control signal is at a high level.

Preferably, the current switching device further includes a contact temperature sampling circuit configured to collect a contact temperature of the relay, where the contact temperature sampling circuit is connected to a control port of the control module.

Preferably, the contact temperature sampling circuit includes a thermistor NTC5 and a capacitor C102, where one end of the thermistor NTC5 and one end of the capacitor C102 are grounded, and the other end of the thermistor NTC5 and the other end of the capacitor C102 are connected and then are connected to the control port of the control module.

Preferably, the current switching device further includes an alarm circuit connected to the control port of the control module.

Preferably, the alarm circuit includes a buzzer BUZ1, where the buzzer BUZ1 is connected to the control port of the control module.

Preferably, the lithium battery voltage sampling circuit includes a resistor R142 and a resistor R143 for voltage division, and the resistor R142 and the resistor R143 are connected in series, where the resistor R142 is connected to a positive electrode of the emergency start power supply.

Preferably, the lithium battery voltage sampling circuit further includes a diode ZD14, a capacitor C105, and a resistor R141, where one end of the diode ZD14, one end of the capacitor C105, and one end of the resistor R141 are connected and then are connected to the control port of the control module, the other end of the diode ZD14, the other end of the capacitor C105, and the resistor R143 are grounded, and the other end of the resistor R141 is connected between the resistor R142 and the resistor R143.

Preferably, the battery voltage sampling circuit includes a resistor R153 and a resistor R154 for voltage division, and the resistor R153 and the resistor R154 are connected in series, where the resistor R153 is connected to the positive electrode of the car battery.

Preferably, the battery voltage sampling circuit further includes a diode ZD15, a capacitor C115, and a resistor R155, where one end of the diode ZD15, one end of the capacitor C115, and one end of the resistor R155 are connected and then are connected to the control port of the control module, the other end of the capacitor C115, the other end of the diode ZD15, and the resistor R154 are grounded, and the other end of the resistor R155 is connected between the resistor R153 and the resistor R154.

Preferably, the current switching device further includes an auxiliary power supply module configured to supply power to the control module.

According to the present utility model, the emergency start power supply maintains the same ground potential with the car battery in the whole process, and the control module can conveniently and accurately sample the battery voltage of the car online, thereby stably implementing a function of emergency start of the car. According to the present utility model, a voltage difference between the emergency start power supply and the car battery is effectively reduced by the precharging circuit connected in parallel between relay contacts, so that arc column energy generated at the moment of closing the relay contacts is reduced, a temperature rise of the contacts of the relay is correspondingly reduced, and the contacts of the relay are protected, thereby extending the service life of the relay itself.

### BRIEF DESCRIPTION OF THE DRAWINGS

To more clearly illustrate the technical solutions in the embodiments of the present utility model or in the prior art, the accompanying drawings that need to be used in the description of the embodiments or the prior art will be briefly introduced below. Apparently, the accompanying drawings in the description below merely illustrate some embodiments of the present utility model. Those of ordinary skill in the art may also derive other accompanying drawings from these accompanying drawings without creative efforts.

FIG. 1 is a principle diagram of a lithium battery voltage sampling circuit;

FIG. 2 is a principle diagram of a battery voltage sampling circuit;

FIG. 3 is a principle diagram of a precharging circuit;

FIG. 4 is a principle diagram of a temperature sampling circuit;

FIG. 5 is a principle diagram of a relay;

FIG. 6 is a principle diagram of an alarm circuit; and

FIG. 7 is a principle diagram of a control module.

### DETAILED DESCRIPTION OF THE EMBODIMENTS

The technical solutions in the embodiments of the present utility model will be clearly and completely described below with reference to the accompanying drawings in the embodiments of the present utility model. Apparently, the described embodiments are merely some rather than all of the embodiments of the present utility model. All other embodiments obtained by those of ordinary skill in the art based on the embodiments in the present utility model without creative efforts shall fall within the scope of protection of the present utility model.

A current switching device for an emergency start power supply of a car includes a lithium battery voltage sampling circuit, a battery voltage sampling circuit, a control module, a precharging circuit, a relay, a contact temperature sampling circuit, an alarm circuit, and an auxiliary power supply module.

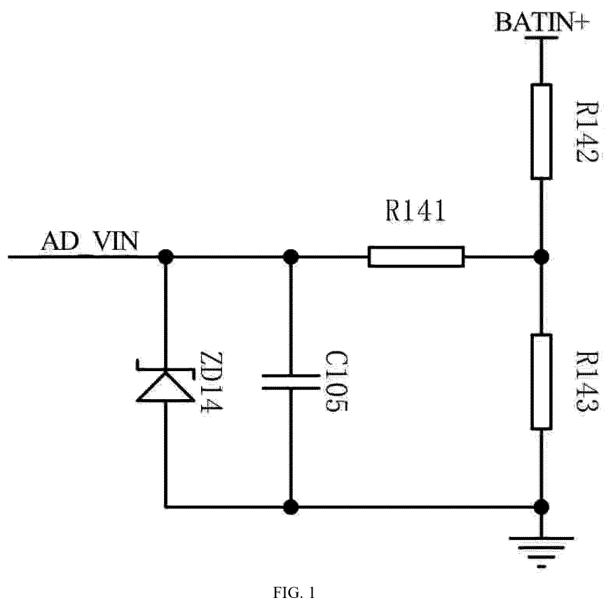

As shown in FIG. 1, the lithium battery voltage sampling circuit is configured to collect a lithium battery voltage in the emergency start power supply. The lithium battery voltage sampling circuit includes a resistor R142 and a resistor R143 for voltage division, and the resistor R142 and the resistor R143 are connected in series, where the resistor R142 is connected to a positive electrode of the emergency start power supply. More specifically, the lithium battery voltage sampling circuit further includes a diode ZD14, a capacitor C105, and a resistor R141, where one end of the diode ZD14, one end of the capacitor C105, and one end of the resistor R141 are connected and then are connected to a control port of the control module, the other end of the diode ZD14, the other end of the capacitor C105, and the resistor R143 are grounded, and the other end of the resistor R141 is connected between the resistor R142 and the resistor R143.

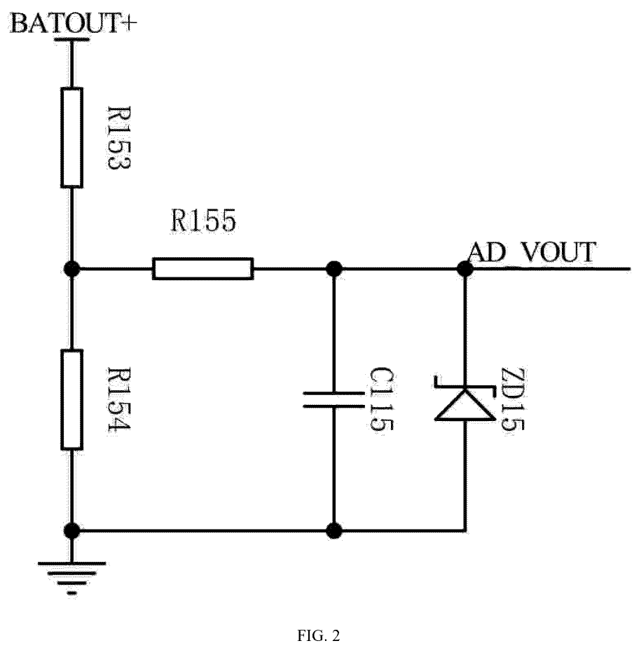

As shown in FIG. 2, the battery voltage sampling circuit is configured to collect a battery voltage of the car. The battery voltage sampling circuit includes a resistor R153 and a resistor R154 for voltage division, and the resistor R153 and the resistor R154 are connected in series, where the resistor R153 is connected to a positive electrode of a car battery. More preferably, the battery voltage sampling circuit further includes a diode ZD15, a capacitor C115, and a resistor R155, where one end of the diode ZD15, one end of the capacitor C115, and one end of the resistor R155 are connected and then are connected to the control port of the control module, the other end of the capacitor C115, the other end of the diode ZD15, and the resistor R154 are grounded, and the other end of the resistor R155 is connected between the resistor R153 and the resistor R154.

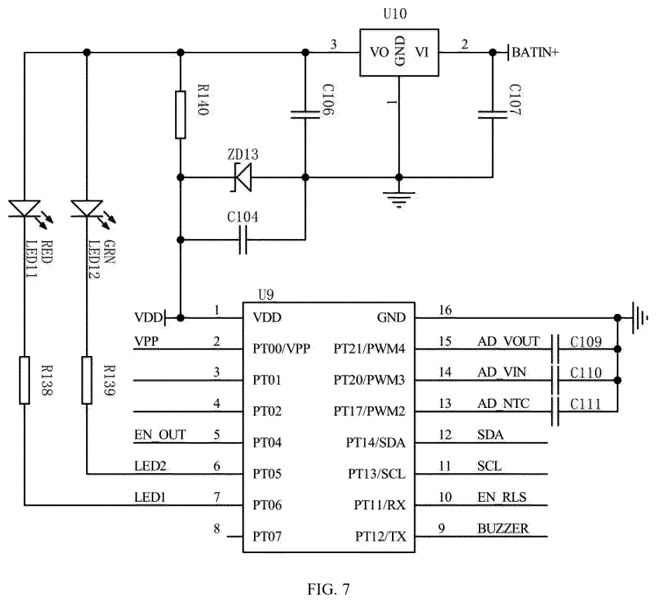

As shown in FIG. 7, the control module is configured to output a first control signal EN_RLS and a second control signal EN_OUT based on the lithium battery voltage and the battery voltage. The current switching device further includes an auxiliary power supply module U10, where the auxiliary power supply module U10 is configured to supply power to the control module.

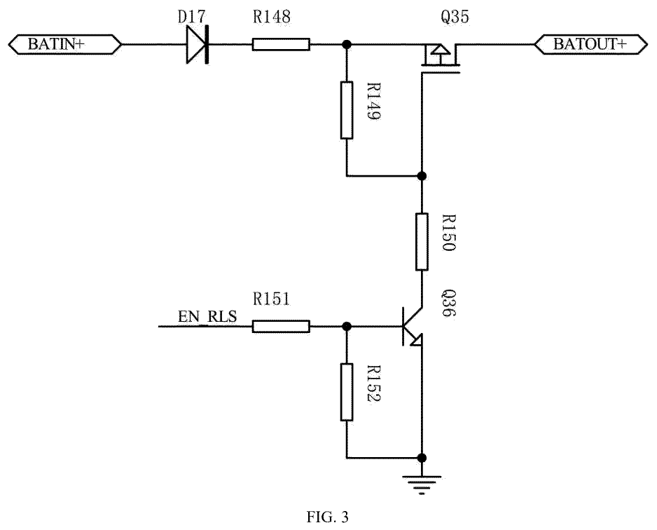

As shown in FIG. 3, the precharging circuit is configured to transmit lithium battery energy of the emergency start power supply into the battery based on a first current when the first control signal EN_RLS is at a high level. More specifically, the precharging circuit further includes a diode D17, a resistor R148, a resistor R149, a resistor R150, a resistor R151, a resistor R152, a triode Q35, and a triode Q36.

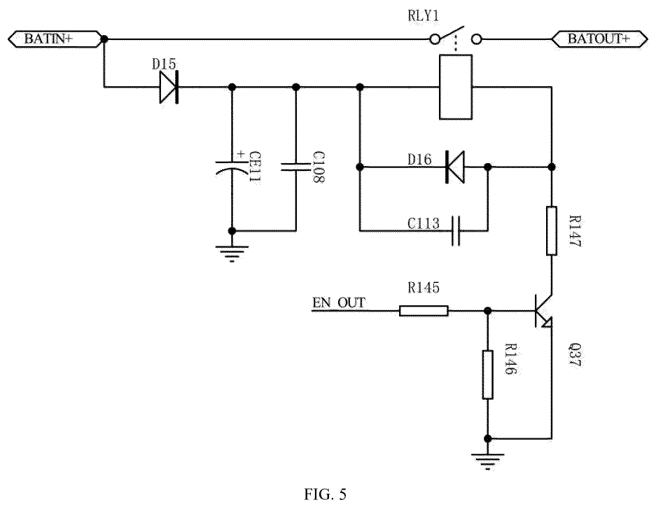

As shown in FIG. 5, the relay is configured to transmit the lithium battery energy of the emergency start power supply into the battery based on a second current when the second control signal EN_OUT is at a high level. More specifically, a control circuit of the relay includes a diode D5, a capacitor CE11, a capacitor C108, a contact RLY1, a diode D16, a capacitor C113, a resistor R145, a resistor R146, a resistor R147, and a triode Q37.

The current switching device further includes a contact temperature sampling circuit configured to collect a contact temperature of the relay, where the contact temperature sampling circuit is connected to the control port of the control module.

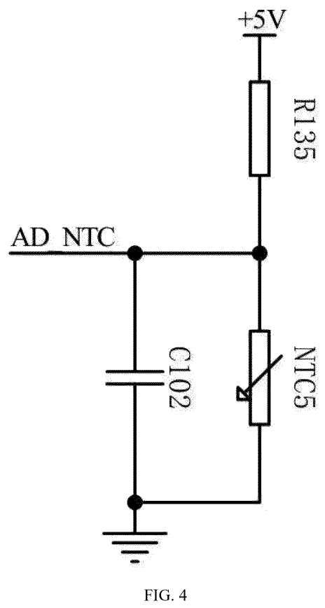

As shown in FIG. 4, the contact temperature sampling circuit includes a thermistor NTC5 and a capacitor C102, where one end of the thermistor NTC5 and one end of the capacitor C102 are grounded, and the other end of the thermistor NTC5 and the other end of the capacitor C102 are connected and then are connected to the control port of the control module.

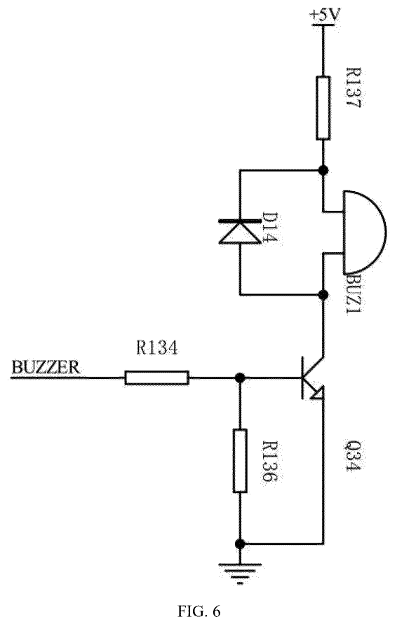

As shown in FIG. 6, the current switching device further includes an alarm circuit, where the alarm circuit is connected to the control port of the control module and includes a buzzer BUZ1, and the buzzer BUZ1 is connected to the control port of the control module. More specifically, the alarm circuit further includes a resistor R134, a resistor R136, a triode Q34, a diode D14, and a resistor R137.

According to the present utility model, during use, the control module first samples the lithium battery voltage in the emergency start power supply by the resistor R142 and the resistor R143 of the lithium battery voltage sampling circuit. When it is detected that the lithium battery voltage is less than 10.5 V or greater than 17.5 V, the second control signal EN_OUT outputted by the control module is at a low level, the relay is open, a protection state is entered, and the buzzer BUZ1 of the alarm circuit gives an alarm. It is to be noted that a case where a voltage of the power supply is lower 10.5 V also includes a case where a voltage of short circuit is 0 V. After the emergency start power supply is connected to the car battery, the control module collects the battery voltage by the resistor R153 and the resistor R154 of the battery voltage sampling circuit, and after that, two states exist. In a first state, when it is detected that the battery voltage is greater than 18V, the second control signal EN_OUT outputted by the control module is at a low level, the relay is not closed, the protection state is entered, and the buzzer BUZ1 gives an alarm. In a second state, when it is detected that the battery voltage is greater than the lithium battery voltage, the second control signal EN_OUT outputted by the control module is at a low level, the relay is open, but the car can be normally ignited to start up at this time. Additionally, when the emergency start power supply is connected to the car battery and the battery voltage is less than a preset threshold, the first control signal EN_RLS outputted by the control module is at a high level, the triode Q35 and the triode Q36 are turned on, and the emergency start power supply performs current-limiting charging on the battery by the resistor R148, that is, the battery is charged based on the first current. When a voltage difference AV between the lithium battery voltage and the battery voltage gradually decreases to the preset threshold, the second control signal EN_OUT becomes a high level, the relay is closed, and the emergency start power supply instantly releases a 100 A current to help start a car engine. On the contrary, if the detected battery voltage is within the normal range and is connected normally, then the second control signal EN_OUT is at a high level, and the relay is closed. During the process, there is no need to perform current-limiting charging on the battery by the precharging circuit.

In the whole usage process, the temperature sampling circuit continuously detects a temperature of a solder pad for relay contacts. When the temperature of the solder pad reaches an over-temperature protection point of 130° C., a voltage of AD_NTC changes from 4 V to 1 V. At this time, the level of the second control signal EN_OUT is inverted to a low level, the relay is open, and the output is turned off, thereby implementing a function of output over-current protection.

When the situations such as overvoltage or undervoltage of the lithium battery, reverse connection or short circuit of the battery, overtemperature, and start timeout are detected, the BUZZER is at a high level. After the triode Q34 is turned on, the buzzer BUZ1 is powered to make an alarm sound, thereby reminding an operator to handle the situation in a timely manner.

The various embodiments in this specification are described in a progressive manner, with each embodiment focusing on the differences from other embodiments. The same or similar parts among the various embodiments can be referred to each other.

1. A current switching device for an emergency start power supply of a car, comprising:
a lithium battery voltage sampling circuit configured to collect a lithium battery voltage in the emergency start power supply;
a battery voltage sampling circuit configured to collect a battery voltage of the car;
a control module configured to output a first control signal and a second control signal based on the lithium battery voltage and the battery voltage;
a precharging circuit configured to transmit lithium battery energy of the emergency start power supply into a battery based on a first current when the first control signal is at a high level; and
a relay configured to transmit the lithium battery energy of the emergency start power supply into the battery based on a second current when the second control signal is at a high level.

2. The current switching device for an emergency start power supply of a car according to claim 1, wherein the current switching device further comprises a contact temperature sampling circuit configured to collect a contact temperature of the relay, wherein the contact temperature sampling circuit is connected to a control port of the control module.

3. The current switching device for an emergency start power supply of a car according to claim 2, wherein the contact temperature sampling circuit comprises a thermistor NTC5 and a capacitor C102, one end of the thermistor NTC5 and one end of the capacitor C102 are grounded, and the other end of the thermistor NTC5 and the other end of the capacitor C102 are connected and then are connected to the control port of the control module.

4. The current switching device for an emergency start power supply of a car according to claim 1, wherein the current switching device further comprises an alarm circuit connected to a control port of the control module.

5. The current switching device for an emergency start power supply of a car according to claim 4, wherein the alarm circuit comprises a buzzer BUZ1, and the buzzer BUZ1 is connected to the control port of the control module.

6. The current switching device for an emergency start power supply of a car according to claim 1, wherein the lithium battery voltage sampling circuit comprises a resistor R142 and a resistor R143 for voltage division, and the resistor R142 and the resistor R143 are connected in series, wherein the resistor R142 is connected to a control port of the emergency start power supply.

7. The current switching device for an emergency start power supply of a car according to claim 5, wherein the lithium battery voltage sampling circuit further comprises a diode ZD14, a capacitor C105, and a resistor R141, one end of the diode ZD14, one end of the capacitor C105, and one end of the resistor R141 are connected and then are connected to the control port of the control module, the other end of the diode ZD14, the other end of the capacitor C105, and the resistor R143 are grounded, and the other end of the resistor R141 is connected between the resistor R142 and the resistor R143.

8. The current switching device for an emergency start power supply of a car according to claim 1, wherein the battery voltage sampling circuit comprises a resistor R153 and a resistor R154 for voltage division, and the resistor R153 and the resistor R154 are connected in series, wherein the resistor R153 is connected to a positive electrode of the car battery.

9. The current switching device for an emergency start power supply of a car according to claim 7, wherein the battery voltage sampling circuit further comprises a diode ZD15, a capacitor C115, and a resistor R155, one end of the diode ZD15, one end of the capacitor C115, and one end of the resistor R155 are connected and then are connected to the control port of the control module, the other end of the capacitor C115, the other end of the diode ZD15, and the resistor R154 are grounded, and the other end of the resistor R155 is connected between the resistor R153 and the resistor R154.

10. The current switching device for an emergency start power supply of a car according to claim 1, wherein the current switching device further comprises an auxiliary power supply module configured to supply power to the control module.
